(19) United States
(12) Patent Application Publication
(10) Pub. No.: US 2023/0047478 A1
(43) Pub. Date: Feb. 16, 2023

(54) METHOD AND SYSTEM FOR LEARNING AN ENSEMBLE OF NEURAL NETWORK KERNEL CLASSIFIERS BASED ON PARTITIONS OF THE TRAINING DATA

(71) Applicant: Palo Alto Research Center Incorporated, Palo Alto, CA (US)

(72) Inventors: Alejandro E. Brito, Mountain View, CA (US); Bashir Sadeghi, East Lansing, MI (US); Shantanu Rane, Palo Alto, CA (US)

(73) Assignee: Palo Alto Research Center Incorporated, Palo Alto, CA (US)

(21) Appl. No.: 17/400,016

(22) Filed: Aug. 11, 2021

(51) Int. Cl. G06N 3/08; G06N 3/04; G06N 20/10; G06N 20/20; G06K 9/62

(52) U.S. Cl. CPC G06N 3/08; G06K 9/628; G06K 9/6261; G06N 3/0454; G06N 20/10; G06N 20/20

(57) ABSTRACT

A method and system are provided which facilitate construction of an ensemble of neural network kernel classifiers. The system divides a training set into partitions. The system trains, based on the training set, a first neural network encoder to output a first set of features, and trains, based on each respective partition of the training set, a second neural network encoder to output a second set of features. The system generates, for each respective partition, based on the first and second set of features, kernel models which output a third set of features. The system classifies, by a classification model, the training set based on the third set of features. The generated kernel models for each respective partition and the classification model comprise the ensemble of neural network kernel classifiers. The system predicts a result for a testing data object based on the ensemble of neural network kernel classifiers.

### STATEMENT OF GOVERNMENT-FUNDED RESEARCH

This invention was made with U.S. government support under (Contract No.) Award Number: HR00111990075 awarded by the Defense Advanced Research Projects Agency (DARPA). The U.S. government has certain rights in the invention.

### RELATED APPLICATIONS

This application is related to:

U.S. Application No. 17/158,631 (Attorney Docket No. PARC-20190576US01), entitled “System and Method for Reasoning About the Diversity and Robustness of an Ensemble of Classifiers,” by inventors Shantanu Rane, Alejandro E. Brito, and Hamed Soroush, filed 26 Jan. 2021 (hereinafter “App. No. 17/158,631”); and

U.S. Application No. 17/345,996 (Attorney Docket No. PARC-20200538US01), entitled “Method and System for Creating an Ensemble of Machine Learning Models to Defend Against Adversarial Examples,” by inventors Alejandro E. Brito and Shantanu Rane, filed 11 Jun. 2021 (hereinafter “App. No. 17/345,996”),

the disclosures of which are herein incorporated by reference in their entirety.

### BACKGROUND

### Field

This disclosure is generally related to machine learning and data classification. More specifically, this disclosure is related to a method and system for learning an ensemble of neural network kernel classifiers based on partitions of the training data.

### Related Art

In the field of machine learning, adversarial examples can exploit the way that artificial intelligence algorithms work in order to disrupt the behavior of the algorithms. Recently, an increasing number and types of attacks have been devised in order to fool the algorithms, along with increasingly stronger defenses against such attacks. One large class of these attacks is “perturbation-bounded evasion attacks,” which involve adversarial examples constructed by perturbing data samples with the goal of forcing a classifier to misclassify them. Such evasion attacks comprise a predominant class of attacks considered in current machine learning technology. One specific type of evasion attack involves adversarial examples which can be trivially classified by a human but can fool a machine learning classifier.

One solution to address these evasion attacks is to use an ensemble or collection of classifiers. A system and method for reasoning about the diversity and robustness of an ensemble of classifiers is described in App. No. 17/158,631, and a method and system for creating an ensemble of machine learning models based on universal kernels to defend against adversarial examples is described in App. No. 17/345,996. Kernel methods generally involve using a linear classifier to solve a non-linear problem, and have been used to evaluate the distribution of a set of training data objects, which can result in producing a classification for each training data object.

However, as the complexity of a training dataset increases, and may contain certain non-linearities which may be challenging for a kernel method using a linear classifier, the challenge remains to create a sophisticated system which can both learn an improved representation of the underlying dataset and result in increased accuracy in classifying subsequent testing data.

### SUMMARY

One embodiment provides a system which facilitates construction of an ensemble of neural network kernel classifiers. In this disclosure, the term “neural network encoder” is used to define a neural network with one or more layers that is used to learn efficient representations of labeled data. These data encodings, also known as features embeddings, can be more efficiently used by a classifier to learn to discriminate data from multiple classes. During operation, the system trains, based on a training set of data objects, a first neural network encoder to output a first set of features. The system divides the training set of data objects into a number of partitions. The system trains, based on each respective partition of the training set of data objects, a second neural network encoder to output a second set of features. The system generates, for each respective partition, based on the first and second set of features, kernel models which output a third set of features. The system classifies, by a classification model, the training set of data objects based on the third set of features, wherein the generated kernel models for each respective partition and the classification model comprise the ensemble of neural network kernel classifiers. The system predicts a result for a testing data object based on the ensemble of neural network kernel classifiers.

In some embodiments, dividing the training set of data objects into the number of partitions comprises dividing the training set of data objects into a number of classes based on a respective class associated with a respective data object.

In some embodiments, dividing the training set of data objects into the number of partitions comprises dividing the training set of data objects randomly into the number of partitions.

In some embodiments, a respective kernel model comprises one or more of: a Gaussian kernel; a universal kernel in a Reproducing Kernel Hilbert Space (RKHS); a linear kernel; a kernel mapping; and a kernel with a corresponding closed-form mathematical expression.

In some embodiments, the classification model comprises one or more of: a linear classifier; a support vector machine (SVM) classifier; a logistic regression classifier; and a multiple-class classifier.

In some embodiments, the classification model comprises a softmax classification layer.

In some embodiments, the first neural network encoder, a respective second neural network encoder trained based on a respective partition, a respective kernel model generated for the respective partition, and a classification model comprise a combined neural network kernel (NNK) model which is based on parameters.

In some embodiments, the system determines a forward iteration, wherein an input of the combined neural network kernel model comprises the training set of data objects and data objects in the respective partition. The system also defines a back propagation iteration, wherein known labels of the training set of data objects enable the combined neural network kernel model to change one or more parameters to ensure that the classification of the training set of data objects is consistent with the known labels.

In some embodiments, the testing data object is modified based on an adversarial technique.

### BRIEF DESCRIPTION OF THE FIGURES

FIG. 1 presents an exemplary environment which facilitates construction of an ensemble of neural network kernel classifiers, in accordance with an embodiment of the present application.

FIG. 2A presents an exemplary architecture which facilitates construction of an ensemble of neural network kernel classifiers, in accordance with an embodiment of the present application.

FIG. 2B presents an exemplary architecture which facilitates construction of an ensemble of neural network kernel classifiers and provides a higher-level view of the architecture of FIG. 2A, in accordance with an embodiment of the present application.

FIG. 3 presents a flowchart illustrating a method for facilitating construction of an ensemble of neural network kernel classifiers, in accordance with an embodiment of the present application.

FIG. 4 depicts a table indicating an exemplary confusion matrix for the evaluation of clean test data, using a class membership method, in accordance with an embodiment of the present application.

FIG. 5 depicts a table indicating an exemplary confusion matrix for data perturbed based on a Fast Gradient Sign Method (FGM) attack, using a class membership method, in accordance with an embodiment of the present application.

FIG. 6 presents an exemplary computer and communication system which facilitates construction of an ensemble of neural network kernel classifiers, in accordance with an embodiment of the present application.

FIG. 7 presents an exemplary apparatus which facilitates construction of an ensemble of neural network kernel classifiers, in accordance with an embodiment of the present application.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

The embodiments described herein solve the problem of handling the increasing complexity of underlying data distribution and its accurate classification by providing a system which creates an ensemble of neural network kernel classifiers. The system can partition a training dataset, train neural network encoders on the entire training dataset and partitions of the training dataset, generate a combined kernel, and use a classification model to generate predicted results.

As described above, in the field of machine learning, adversarial examples can exploit the way that artificial intelligence algorithms work in order to disrupt the behavior of the algorithms. Recently, an increasing number and types of attacks have been devised in order to fool the algorithms, along with increasingly stronger defenses against such attacks. One large class of these attacks is “perturbation-bounded evasion attacks,” which involve adversarial examples constructed by perturbing data samples with the goal of forcing a classifier to misclassify them. Such evasion attacks comprise a predominant class of attacks considered in current machine learning technology. One specific type of evasion attack involves adversarial examples which can be trivially classified by a human but can fool a machine learning classifier.

One solution to address these evasion attacks is to use an ensemble or collection of classifiers. For example, a system and method for reasoning about the diversity and robustness of an ensemble of classifiers is described in App. No. 17/158,631, which further describes analyzing robustness against adversarial examples using linear models derived from convolutional neural network (CNNs).

Furthermore, kernel methods generally involve using a linear classifier to solve a non-linear problem and have been used to learn the underlying distribution of a set of training data objects, which can result in producing accurate classification for each training data objects sampled from the underlying distribution. Kernel functions can use high-dimensional feature space without using or computing coordinates in high-dimensional space, and can generally be expressed in closed form. A method and system for creating an ensemble of machine learning models based on universal kernels to defend against adversarial examples is described in App. No. 17/345,996, which also describes how to approximate any continuous non-linear classifier with arbitrary precision. In particular, App. No. 17/345,996 describes a system and method which uses kernel-based classifiers in a Reproducing Kernel Hilbert Space (RKHS) to learn the distribution of both the training set in full and the partitioned data as the bases (e.g., by using the training set which is divided into partitions).

However, as the complexity of a training dataset underlying distribution increases, this may contain certain non-linearities which may be challenging for a kernel-based classifier to accurately learn, and the challenge remains to create a sophisticated system which can learn an improved representation of the underlying dataset and result in increased accuracy in classifying subsequent testing data, as well as provide improved performance against perturbation-bounded evasion attacks.

The embodiments described herein addresses these challenges by using neural network models to extract feature information, feeding the extracted feature information into a universal kernel, and using the output of the kernel in a classifier to provide a predicted result for the training dataset and subsequent testing data. This classifier can be implemented in a neural network model by a classification layer. In other embodiments, the output of the kernel may be fed to a classifier which is implemented in a different way. For example, a system can be the composition of the neural network kernel model without the classification layer plus a support vector machine (SVM), or any other model which can be used for supervised classification tasks. The current approach of the described embodiments can extend the prior approach described in App. No. 17/345,996 to include practical classifiers, specifically, neural network models or classifiers.

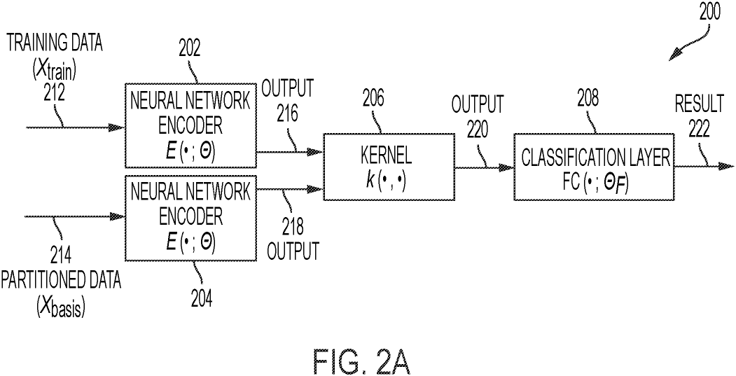

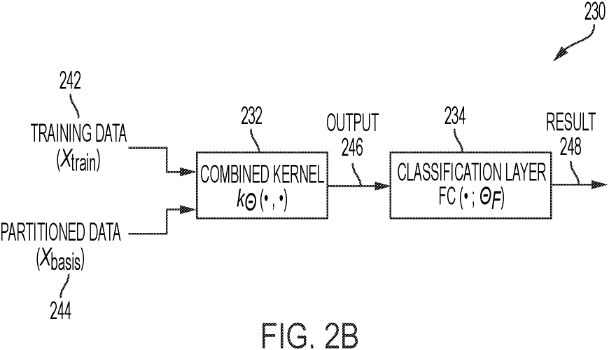

The described system can include two neural network encoders, a kernel function, and a classification layer, as described below in relation to FIG. 2A. Given a training set of data objects, the system can divide the training dataset into a number of partitions of data, e.g., based on a random shuffling method or a class membership method. The first neural network encoder can take as input a training set of data objects, and can output features of the training dataset (“first set of features”). The second neural network encoder can take as input “basis data” which can comprise data objects from a partition of the training dataset, and can output features of the partitioned basis data (“second set of features”). These two neural network encoders can pass their outputs to a generalized kernel model. The kernel model can include a Gaussian kernel, a linear kernel, a kernel mapping, or any known kernel which can be represented by a closed form mathematical expression.

Rather than using the kernel to learn parameters, instead the system merely uses the kernel mechanism directly to produce a more efficient feature representation for the purpose of generating a more accurate classification result. That is, the kernel itself has no parameters. The kernel model can output features associated with the training data set and the basis data (“third set of features”) and pass this third set of features to a classifier, such as a fully connected classification layer or module. This fully connected classification layer can include a multi-classification stage in which the classification layer can classify data that is associated with multiple classes, e.g., produce or predict an output, a class, or a label for a given data object. The classification layer or module can be, e.g., a linear classifier, a support vector machine (SVM) classifier, a logistic regression classifier, or a multiple-class classifier. That is, the system can be trained to learn how to classify features which are output from the kernel function. The two neural network encoders, the kernel model, and the classification layer or module can be referred to as a “combined neural network kernel classifier” or as a “combined neural network kernel model” (which terms are used interchangeably in this disclosure). The system can create a combined neural network kernel classifier using each of the number of partitions of the training dataset. This can result in the construction of an ensemble of combined neural network kernel classifiers which are each based on partitions of the training dataset.

The described embodiments train the neural networks (e.g., a respective neural network encoder) to learn the features from the training set (both as the full training set and as the partitioned basis data), which allows the kernel and classifier models to simply reason only upon the features output by the neural network encoders. This can result in an improved performance because the kernel model and the neural network encoders, in conjunction, can represent the complexity of the underlying distribution of the training dataset more efficiently.

Training the neural network encoders can also involve learning the parameters, which allows the classification model to classify the output of the kernel using the parameters. The kernel model itself, as depicted in relation to FIG. 2A, does not have any of its parameters learned during training, although in some embodiments, the kernel model can involve learning of some parameters of the kernel function for a more sophisticated learning process. An exemplary diagram of an architecture which includes two neural network encoders, a kernel model, and a classification layer or module is described below in relation to FIG. 2A.

In addition, the system described in FIG. 2A (i.e., with two neural network encoders, a kernel model, and a classification layer or module) can be depicted with the neural network encoders (as parameterized by θ) and the kernel model (e.g., the RKHS kernel k(·, ·) combined as a single kernel encoder. This single combined neural network kernel encoder can be parameterized by θ, as depicted below in relation to FIG. 2B.

### Exemplary Environment for Construction of Ensemble of Neural Network Kernel Classifiers

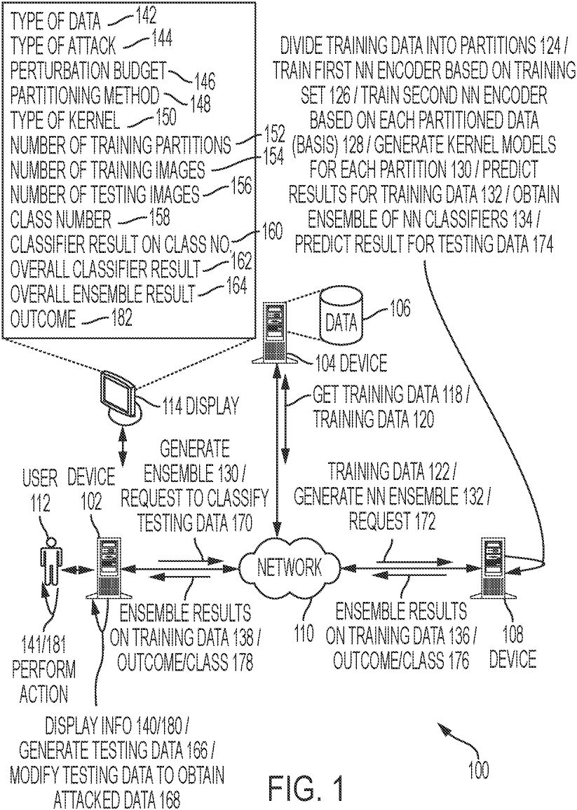

FIG. 1 presents an exemplary environment 100 which facilitates construction of an ensemble of neural network kernel classifiers, in accordance with an embodiment of the present application. Environment 100 can include: a device 102, an associated user 112, and an associated display screen 114; a device 104 and an associated or included storage device 106; and a device 108. Devices 102, 104, and 108 can communicate with each other via a network 110. Device 102 can be a client computing device, e.g., a laptop computer, a mobile telephone, a smartphone, a tablet, a desktop computer, and a handheld device. Devices 102, 104, and 108 can be a computing device, e.g., a server, a networked entity, and a communication device.

During operation, device 108 can request and receive from device 104 training data (not shown), and device 104 can send training data to device 108 (via a get training data 118 communication and training data 120). Device 108 can receive training data 120 (as training data 122), and perform a series of operations to construct an ensemble of neural network kernel classifiers. Upon receiving training data 122, device 108 can divide the training data into partitions (operation 124). Each data object may be associated with one of a plurality of classes. That is, each data object may be associated with a known label. The division of the training data into the partitions can be based on a random shuffling method or on a class membership method, as described herein. Device 108 can train, based on the full training data set, a first neural network encoder to output a first set of features (operation 126). Device 108 can also train, based on each respective partition of the training data set, a second neural network encoder to output a second set of features (operation 128). The first and second neural network encoders can have a same architecture or be based on a same model. In some embodiments, the first and second neural network encoders can use a different architecture or be based on different models.

Furthermore, the data objects in each partition can form the bases for which the second neural network encoder is trained, where the output of features from the second neural network encoder is used to generate the respective kernel model. Thus, the respective kernel model for each respective partition can be considered part of one respective neural network kernel classifier in the overall ensemble of neural network kernel classifiers. That is, for each respective neural network kernel classifier of the ensemble of neural network kernel classifiers, the system can train the respective first neural network encoder based on the entire training data set and can further train the respective second neural network encoder based on the partitions of data, which can define the performance of each neural network kernel classifier.

Device 108 can subsequently generate, for each respective partition of the training data (based on the first and second set of features as output from the first and second neural network encoders in operations 126 and 128), kernel models which output a third set of features (operation 130). Device 108 can classify, by a classification model, the training data set based on the third set of features as output from each respective kernel model (operation 132) (i.e., predict results for the training data). Device 108 can thus obtain an ensemble of neural network kernel (NNK) classifiers (operation 134), where each neural network kernel classifier can comprise a generated kernel model (based on the output from the first and second neural network encoders) and the classification model. Additionally, based on known labels of the overall training data set and the partitioned data, the system can learn and change one or more parameters to ensure that the classification of the training data set is consistent with the known labels.

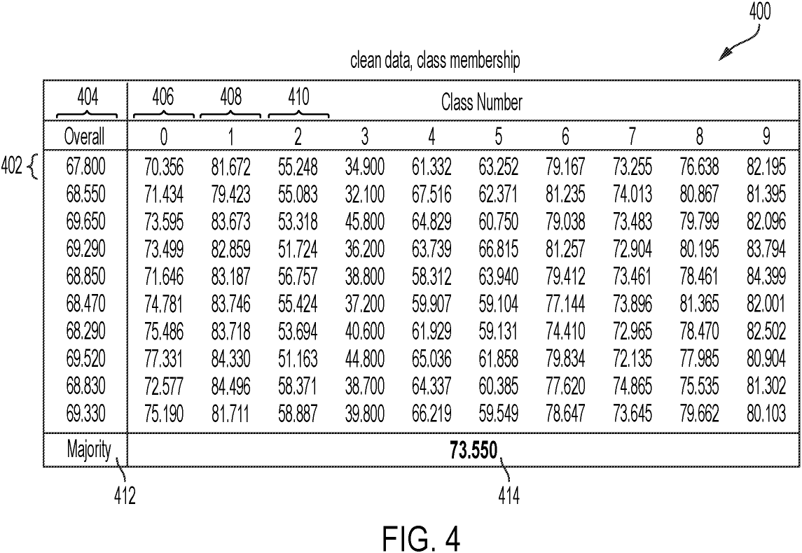

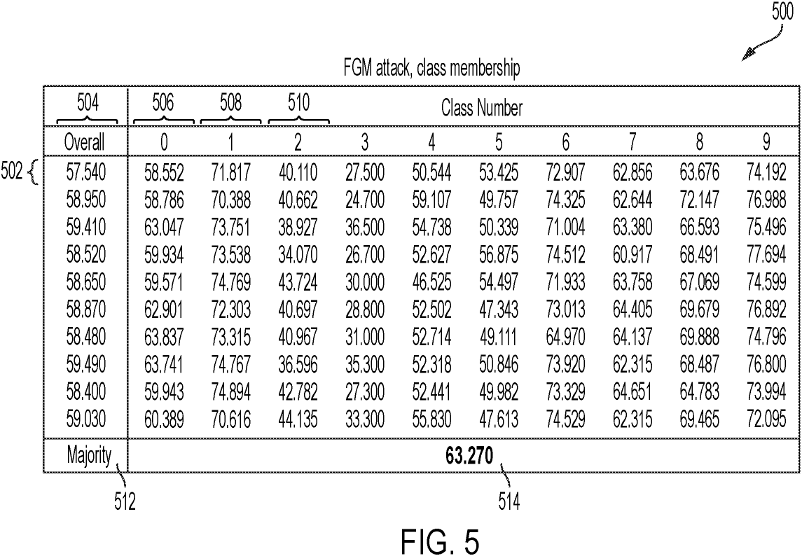

Device 108 can send the result of the ensemble of neural network kernel classifiers on the training data to device 102 (as results 136). Device 102 can receive ensemble results on training data (as results 138), and can perform a display information 140 operation, which can cause to be displayed on display 114 at least: the type of data 142 (e.g., whether the data is clean or based on an adversarial attack); the type of attack 144 (if the data type is data under attack) (e.g., Fast Gradient Sign Method (FGM) or Projected Gradient Descent (PGD) attack); the perturbation budget 146; the partitioning method 148 (e.g., random shuffling or class membership); the type of kernel 150 used to receive the output of the neural network encoders (e.g., a Gaussian kernel, a universal kernel, a linear kernel, etc.); the number of training partitions 152 (e.g., corresponding to the number of classes or a number based on the random shuffling method for partitioning the data); the number of training images 154; the number of testing images 156; the class number 158 (e.g., numbers which each correspond to a specific class); the classifier result on a given class number 160; the overall classifier result 162 (e.g., the result of a respective classifier across all classes); the overall ensemble result 164 (e.g., as based on an ensemble decision rule such as a majority vote or a maximum of an average of a probability of each class as reported by the individual neural network kernel classifiers). As an example, display 114 can include tables 400 or 500, as described below in relation to FIGS. 4 and 5, respectively. The system can display any of the information described above on display 114, in any combination, which can allow user 112 to interact with display 114 to perform additional actions.

User 112 can view the information displayed on display 114, and can perform an action 141. For example, user 112 can change a configuration or setting related to, e.g., the type of attack (144), the partitioning method (148), the type of kernel (150), and a number of training partitions (152). As another example, user 112 may interact with the information presented on display 114 to view detailed information about a specific neural network kernel classifier, class number (158), or classification (160, 162, or 164). In some embodiments, user 112 can select a certain set of neural network kernel classifiers of the displayed or presented ensemble of neural network kernel classifiers (e.g., to view more detailed information), and can also generate (via a user interface widget, not shown) and send an update ensemble command to device 108, as described in App. No. 17/158,631.

Furthermore, user 112, via device 102, can determine or generate a testing data set, including a testing data object (e.g., via an operation 166). The testing data set (and the testing data object) can include data which is modified based on an adversarial technique. For example, user 112 can modify the testing data to obtain “attacked data” or data under attack (operation 168). Device 102 can send a corresponding request to classify the testing data (via a communication 170). Device 108 can receive the request to classify the testing data (as a request 172), and can predict a result (e.g., an outcome/class) for the testing data (operation 174). Operation 174 can include running the previously generated ensemble of neural network kernel classifiers on the testing data.

Device 108 can send a predicted outcome/class 176 to device 102. Device 102 can receive predicted outcome/class 176 (as outcome/class 178), and can perform a display information 180 operation, which can cause certain information to be displayed on display 114, as described above in relation to operation 140. The information displayed on display 114 can further include an outcome 182. For example, display 114 can include table 500, as described below in relation to FIG. 5.

User 112 can perform an action 181, which can be similar to action 141, as described above, e.g., changing a setting, interacting with displayed information, selecting certain neural network kernel classifiers, and generating a command to update the ensemble of neural network kernel classifiers based on user-configured changes.

Thus, by providing user 112 with the requested information via display 114, the system can provide a practical application for the user to interact with the displayed information (e.g., by changing configuration settings and sending commands to update the generated ensemble of neural network kernel classifiers).

### Integrating the Neural Network Into a Kernel Classifier Model

App. No. 17/345,996 describes an implementation of the kernel trick using universal (Gaussian) kernels in a Reproducing Kernel Hilbert Space (RKHS). The described embodiments, in this document, disclose how to integrate the neural network into a RKHS kernel classifier model. FIG. 2A presents an exemplary architecture 200 which facilitates construction of an ensemble of neural network kernel classifiers, in accordance with an embodiment of the present application. Architecture 200 can depict the splitting of a neural network kernel classifier into an “encoder” and a “classifier.” The encoder can include all the convolutional layers, densely connected hidden layers, and all (possibly non-linear) activations, except for the final classification layer. The classifier can include a kernel model and the final layer equipped with an activation function and a loss function, e.g., a softmax classifier or classification layer (which can be implemented as a layer with a linear activation function and a cross-entropy loss function). The kernel model can be, e.g., a trivial (identity) mapping, a linear mapping, a universal kernel, etc.

Thus, as depicted in FIG. 2A, architecture 200 can include: a first neural network encoder 202; a second neural network encoder 204; a kernel 206; and a classification layer 208. The described “encoder” can include first neural network encoder 202 and second neural network encoder 204, while the “classifier” can include kernel 206 (i.e., the kernel model) and classification layer 208 (i.e., the classifier model). During operation, neural network encoder 202 can take as input training data 212 (Xₜᵣₐᵢₙ) and output a first set of features as an output 216. Neural network encoder 204 can take as input partitioned data 214 (X_{basis}) and can output a second set of features as an output 218. Kernel 206 can take as input 216 and 218 from neural network encoders 202 and 204, and can output a third set of features as an output 220. Kernel 206 can map features extracted from the encoder(s) in an optimal manner. That is, kernel 206 can be known to be optimal when provided with accurate features. Finally, classification layer 208 can take as input 220 from kernel 206, and can output a class label prediction or likelihood score of a testing data object or a data set as a result 222 (i.e., the classification of the data set).

Let ε be the space of all neural network encoders form the input space x to the output space Z with a given architecture, parameterized by its weights θ. Furthermore, assume that F is a RKHS with an inner product kernel function k(·, ·) (as shown by kernel 206). Let E(· ; θ) be an arbitrary encoder in ε as shown in FIG. 2A (i.e., neural network encoder 202 and neural network encoder 204). Denote by H_{θ} the Hilbert space generated by the kernel function k_{θ}(· , ·) := k(E(· ; θ),E(· ; θ)) with the inner product 〈· , ·〉_{F}. Now, H_{θ} admits a RKHS if and only if k_{θ}(·, ·) is bounded. For neural networks with bounded weights and bounded activation functions, this condition is satisfied because E(· ; θ) is consequently bounded. The system can thus combine the neural network encoder, parameterized by θ (202 and 204) and the RKHS kernel k(· , ·) (206) into a combined kernel k_{θ}(·, ·) (232 of FIG. 2B), parameterized by θ as described below in relation to FIG. 2B. Classification layer 208 can be indicated as FC (· ; θ_{F}), where θ_{F} can determine how to classify the output of kernel 206.

### Constructing an Ensemble of Neural Network Kernel Classifiers Based on Partitions of the Training Data

FIG. 2B presents an exemplary architecture 230 which facilitates construction of an ensemble of neural network kernel classifiers and provides a higher-level view of the architecture of FIG. 2A, in accordance with an embodiment of the present application. Architecture 230 can include a combined kernel 232 and a classification layer 234. As described above in relation to FIG. 2A, combined kernel 232 can include neural network encoder 202 and neural network encoder 204 as well as kernel 206. Unlike kernel 206 as depicted in FIG. 2A, combined kernel 232 can be parameterized by θ. Combined kernel 232 can take as input both training data 242 (Xₜᵣₐᵢₙ, which comprises the entire training data set) and partitioned data 244 (X_{basis}, which comprises the data from a respective partition of the entire training data set). Combined kernel 232 can perform the functions previously described above in FIG. 2A for neural network encoder 202, neural network encoder 204, and kernel 206, and can generate an output 246 (i.e., the “third set of features”). Classification layer 234 can take as input this third set of features (output 246), and can determine a classification for a particular data object or data set, including a data object in the training set, a data object in the partitioned data of the training set, a testing data object, and a testing data set. Classification layer 234 can output the classification (e.g., predict a result or outcome, i.e., a class label prediction or likelihood score) as a result 248.

As described above in relation to FIG. 1, given a training data set, the system can divide the training data set into a number of partitions. This division can be based on a random shuffling method or a class membership method. Assume that the training data set consists of N samples, and that the data itself consists of M classes, and that there are approximately N/M training samples per class.

In the random shuffling method, the system can randomly sample the training set to create M partitions, where each partition contains approximately N/M training samples. The system can use the training samples from each (randomly shuffled) partition as the basis functions (i.e., partitioned data 214 (X_{basis}) in FIG. 2A and partitioned data 244 (X_{basis}) in FIG. 2B) for training a classifier corresponding to the respective partition.

In the class membership method, the system can determine M partitions, where each partition is defined by the known labels associated with each class of the training data set. Assume that each partition consists of approximately N/M training samples. The system can use the training samples from each (class membership-partitioned) class as the basis functions (i.e., partitioned data 214 (X_{basis}) in FIG. 2A and partitioned data 244 (X_{basis}) in FIG. 2B) for training a classifier corresponding to the respective class or partition. One direct consequence of this approach can be that an ensemble component classifier is well-trained for, and possibly over-fit to, a particular class. Such a classifier may then be most vulnerable to adversarial examples constructed from that class. For example, a classifier trained using the class ‘0’ images as the basis may be expected to perform very accurately on clean images of class ‘0’ but may also be expected to perform poorly on adversarial examples which force the images of class ‘0’ to be classified as other target classes.

Furthermore, as the underlying data distribution (e.g., training data or testing data) increases in complexity, the neural network encoder represented by E(· ; θ) can become wider and deeper as needed. As a result, architecture 200 and architecture 230 depict a system which can train ensembles of neural network kernel classifiers to create not only diverse kernels (e.g., kernel 206 and combined kernel 232) but also diverse sophisticated neural networks. The system described in App. No. 17/345,996 can provide diversity in the kernel classifiers, while the system of the described embodiments can provide diversity in the parameters of the neural networks. That is, while neural network encoders 202 and 204 are depicted with a same architecture or using a same model, the system can create different parameters θ because encoders 202 and 204, and combined kernel 232, are being fed different data (i.e., based on the different data of X_{basis} in partitioned data 214 or 244). Thus, while the underlying neural network model architectures may be the same, the system can provide diversity in the coefficients of the models, by obtaining different data due to the input of the different basis data.

### Forward Iteration and Back Propagation Iteration

The system can perform a forward iteration, which can include taking as input both the full training dataset and the basis data (the partitioned data). While constructing the ensemble of neural network kernel classifiers, the system can determine the known labels of data objects in the full training dataset, and can also determine the known labels of data objects in each respective partition. The system can change the parameters of the neural network by defining a back propagation iteration, where the knowledge of the labels of the training dataset can enable the neural network kernel to change one or more parameters to ensure that the classification of the training dataset and the basis data is consistent with (or reaches a predetermined threshold based on) the known labels.

By performing the forward iteration and the back propagation until a certain predetermined threshold or maximum number of iterations is reached, the system can force the parameters of the neural network to change based on the known labels (and expected classification of the training dataset). These iterations can result in introducing diversity in the ensemble of neural network kernel classifiers.

### Exemplary Method for Constructing an Ensemble of Neural Network Kernel Classifiers

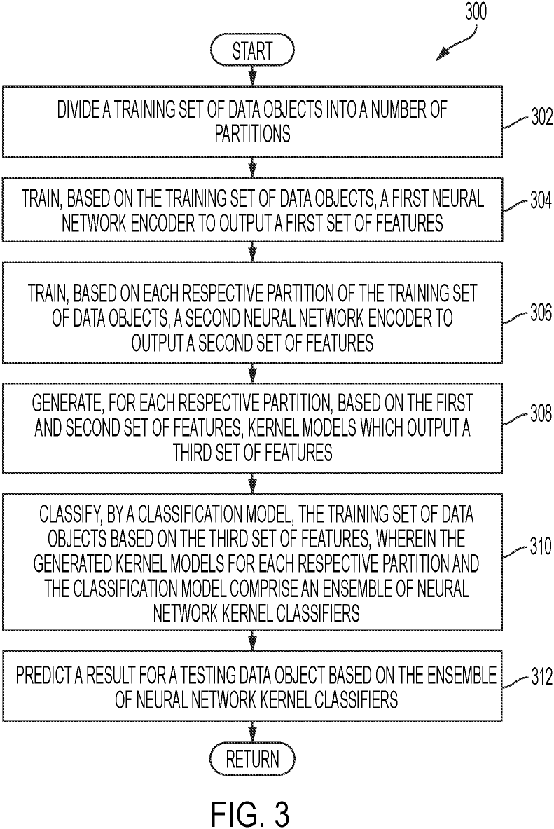

FIG. 3 presents a flowchart 300 illustrating a method for facilitating construction of an ensemble of neural network kernel classifiers, in accordance with an embodiment of the present application. During operation, the system divides the training set of data objects into a number of partitions (operation 302). The system trains, based on the training set of data objects, a first neural network encoder to output a first set of features (operation 304), and trains, based on each respective partition of the training set of data objects, a second neural network encoder to output a second set of features (operation 306). The system generates, for each respective partition, based on the first and second set of features, kernel models which output a third set of features (operation 308). The system classifies, by a classification model, the training set of data objects based on the third set of features, wherein the generated kernel models for each respective partition and the classification model comprise the ensemble of neural network kernel classifiers (operation 310). The system predicts a result for a testing data object based on the ensemble of neural network kernel classifiers (operation 312).

### Concrete Results and Wavs to Construct Ensembles of Neural Network Kernel Classifiers

The below examples are provided to demonstrate the practical application of the described embodiments. The system can implement the neural network kernel classifier constructions, as described herein, and can evaluate the generated constructions of an ensemble of neural network kernel classifiers for classification accuracy and robustness to adversarial examples (e.g., “attacked” data, data which has been perturbed, or data which has been subject to a perturbation-bounded evasion attack).

Assume a training data set includes 50,000 images, which comprises clean data (i.e., does not include any images which have been subjected to perturbation-bounded evasion attacks). The training data set can include partitions (which can correspond to the number of classes associated with the training data set). The training data set can include 10 partitions (or classes, in the case of the class membership method), and each partition can include 1,000 images. The system can train all the neural network kernel classifiers on a clean training data set, and can evaluate the generated neural network kernel classifiers based on clean and adversarial test data sets (as described below in relation to FIG. 4 and FIG. 5). This can result in determining how much improvement in classifier performance can be achieved solely by using ensemble methods, and can also account for an application scenario in which the attack algorithm and parameters are unknown to the defender.

### Exemplary Accuracy of Classifiers and Ensemble of Classifiers on Clean Data: Class Membership Method

FIG. 4 depicts a table 400 indicating an exemplary confusion matrix for the evaluation of clean test data, using a class membership method, in accordance with an embodiment of the present application. In the scenario shown in table 400, each row can represent the performance of a classifier on a given class, and each class can be indicated with a number (e.g., 0-9) per column. For example, a row 402 can indicate a first classifier which is: 70.356% accurate in identifying data from class ’0 (in a column 406); 81.672% accurate in identifying data from class ‘1’ (in a column 408); 55.248% accurate in identifying data from class ‘2’ (in a column 410); etc.

The “Overall” number (in a column 404) can indicate an average of the entire row (e.g., the average accuracy of the classifier in row 402 over all of the classes 0-9). For example, row 402 can indicate that this corresponding classifier has an overall accuracy of 67.800% (in column 404). The system can provide the result of an ensemble decision (such as based on a majority rule or a majority ensemble rule), as shown by a majority 412 row which indicates a value of 73.550% (in an element 414). It can be noted that in table 400, the majority rule (73.550%) is a higher accuracy than the accuracy of any of the individual classifiers (as seen in column 404).

The resulting ten individual classifiers can be trained based on neural network encoders which take as input both the 50,000 images of the training data set as well as the images in a specific partition. The partitions are the result of the training data being divided based on class membership into ten partitions of 1,000 images per partition. As described above, the kernel itself can take the features (“first set of features” and “second set of features” as described above in relation to FIG. 2A and FIG. 2B) output from the neural network encoders and obtain a third set of features. A fully connected classification layer or module can take as input this third set of features, and learn a classification for the training data set. Given clean data, the system can obtain an ensemble of these ten classifiers, which can result in an accuracy of 73.550% for the ensemble classifier based on a majority decision rule.

Specifically, in this example, the kernels of the individual classifiers are based on class membership, such that an individual classifier of i ∈ 0,1, ..., 9 has its RKHS kernels based on the images belonging to class i only (e.g., partitioned data 214 (X_{basis}) of FIG. 2A and partitioned data 244 (X_{basis}) of FIG. 2B). Each partition thus consists of 1,000 images per class. Each individual classifier is again trained on the 50,000 images from all classes (e.g., training data 212 (Xₜᵣₐᵢₙ) of FIG. 2A and training data 242 (Xₜᵣₐᵢₙ) of FIG. 2B). The individual classifiers may differ very slightly in their classification performance. For clean data, this difference is not significant, but given “attacked” data or images under attack, this difference can become appreciable, as described below in relation to FIG. 5.

### Exemplary Accuracy of Classifiers and Ensemble of Classifiers on Attacked Data: Class Membership Method

FIG. 5 depicts a table 500 indicating an exemplary confusion matrix for data perturbed based on a Fast Gradient Sign Method (FGM) attack, using a class membership method, in accordance with an embodiment of the present application. In the scenario of table 500, assume that the same test data set (as in the scenario of FIG. 4) includes test images which are subjected to the FGM attack with a perturbation budget of ∈ = 0.05, and the data is partitioned based on the class membership method. Each of the ten individual classifiers is trained using the neural network encoders, the kernel model, and the classification model or layer described above in relation to FIGS. 2A and 2B.

In table 500, it can be noted that the performance of a classifier trained using the basis for class i 6 0,1, ..., 9 performs poorly under attack for images from class i. For example, the diagonal elements of table 500 tend to be lower than the off-diagonal elements, as in: 58.552% in the first row (a row 502) for class ‘0’ as shown in a column 506; 70.388% in the second row for class ‘1’ as shown in a column 508; and 38.927% in the third row for class ‘2’ as shown in a column 510. Each neural network kernel classifier in the ensemble may perform poorly on a different class, which may result in better diversity than in the case of random shuffling (not shown). Note that while the diagonal elements trend may not be consistent for all classifiers, the trend may still indicate a better diversity for the class membership method over the random shuffling method.

Furthermore, as in table 400, the system can provide the result of the ensemble decision, as shown by a majority 512 row which indicates a value of 63.270% (in an element 514). The majority rule (63.270%) is a higher accuracy than the accuracy of any of the individual classifiers (as seen in column 504).

Thus, tables 400 and 500 of FIGS. 4 and 5 demonstrate the improved effect of an ensemble of neural network kernel classifiers on the classification accuracy of testing data under attack.

### Integration Into a Practical Application and Improvements to Technologies

The embodiments described herein can be integrated into a practical application for, and can result in an improvement in, several technologies and technical fields, including but not limited to: artificial intelligence; machine learning and analytics; neural networks; data mining (including of a significant volume of data); analysis of complex non-linear data; data classification; and defense against adversarial attacks and adversarial examples, including perturbation-bounded evasion attacks.

Users of the system described herein can include an individual with a smartphone, a mobile device, or a computing terminal (e.g., user 112 of environment 100 of FIG. 1). Users of the system can also include any client in a machine learning or an artificial intelligence setting, where increasing the effectiveness of classifiers against adversarial attacks can result in an increase in the accuracy of classification of test data. For example, the tables described above in relation to FIGS. 4 and 5 support the technological improvements of the described embodiments because the tables indicate results which show that under attack, individual classifiers may perform poorly, but using an ensemble of neural network kernel classifiers and an ensemble decision rule (where the ensemble is constructed based on the methods described herein, e.g., dividing the training data into partitions to generate classifiers while training the classifiers over the entire training data set), the accuracy of the ensemble decision may be greater than the accuracy of any individual neural network kernel classifier.

Furthermore, the described embodiments provide an improvement to technology because the system allows a user to interact with the created ensembles and resulting classifications (as shown in the exemplary information displayed in display 114 of FIG. 1). The system can result in more efficiently training the machine learning models against adversarial examples, which can result both in an improved model and a more efficient overall user experience.

### Exemplary Computer and Communication System

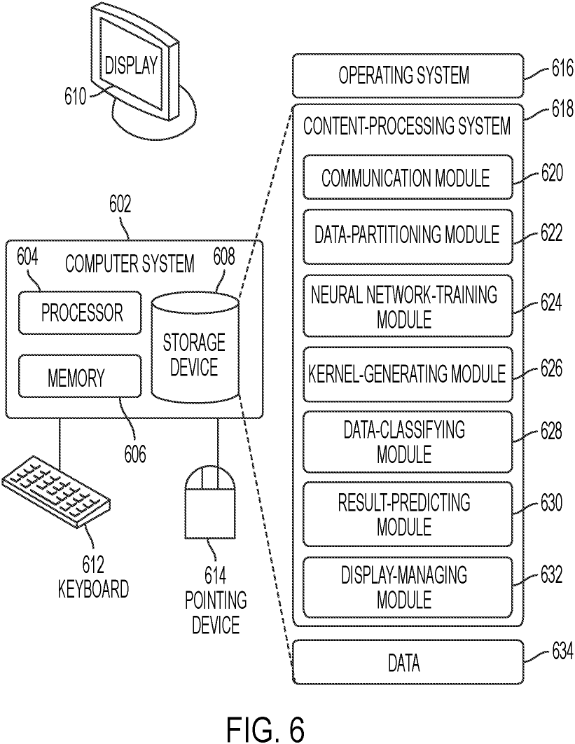

FIG. 6 presents an exemplary computer and communication system 602 which facilitates construction of an ensemble of neural network kernel classifiers, in accordance with an embodiment of the present application. Computer system 602 includes a processor 604, a memory 606, and a storage device 608. Memory 606 can include a volatile memory (e.g., RAM) that serves as a managed memory, and can be used to store one or more memory pools. Furthermore, computer system 602 can be coupled to a display device 610, a keyboard 612, and a pointing device 614. Storage device 608 can store an operating system 616, a content-processing system 618, and data 634.

Content-processing system 618 can include instructions, which when executed by computer system 602, can cause computer system 802 to perform methods and/or processes described in this disclosure. Specifically, content-processing system 618 may include instructions for sending and/or receiving data packets to/from other network nodes across a computer network (communication module 620). A data packet can include data, data objects, a data set, a request, a command, a model, a classifier, training data, and test data.

Content-processing system 618 can further include instructions for dividing the training set of data objects into a number of partitions (data-partitioning module 622). Content-processing system 618 can also include instructions for training, based on the training set of data objects, a first neural network encoder to output a first set of features, and for training, based on each respective partition of the training set of data objects, a second neural network encoder to output a second set of features (neural network-training module 624). Content-processing system 618 can include instructions for generating, for each respective partition, based on the first and second set of features, kernel models which output a third set of features (kernel-generating module 626). Content-processing system 618 can additionally include instructions for classifying, by a classification model, the training set of data objects based on the third set of features, wherein the generated kernel models for each respective partition and the classification model comprise the ensemble of neural network kernel classifiers (data-classifying module 628). Content-processing system 618 can include instructions for predicting a result for a testing data object based on the ensemble of neural network kernel classifiers (result-predicting module 630).

Content-processing system 618 can further include instructions for displaying neural network kernel classifier and ensemble-related information on a display associated with a computing device of a user (display-managing module 632). Content-processing system 618 can include instructions for allowing a user to interact with the displayed information (display-managing module 632).

Data 634 can include any data that is required as input or that is generated as output by the methods and/or processes described in this disclosure. Specifically, data 634 can store at least: data; a set of data; a training set of data objects; a class or plurality of classes; a divided set of data; a partitioned set of data; a partition of data; a number of partitions; a machine learning model; a classifier; a neural network kernel classifier; a neural network encoder; a kernel; a universal kernel; a Gaussian kernel; a kernel in an RKHS; an ensemble of neural network kernel classifiers; a classification; a confusion matrix; an accuracy of a single classifier; an overall accuracy of a single classifier over multiple classes; an ensemble decision rule; an accuracy of an ensemble of classifiers; an outcome; a predicted outcome; testing data; a testing data object; an indicator of a random shuffling method or a class membership method; data which has been modified based on a perturbation-bounded evasion attack; a number of a plurality of classes; a random number; a type of data; a type of attack; a perturbation budget; a partitioning method; a type of kernel; a number of training partitions; a number of training images; a number of testing images; a class number;

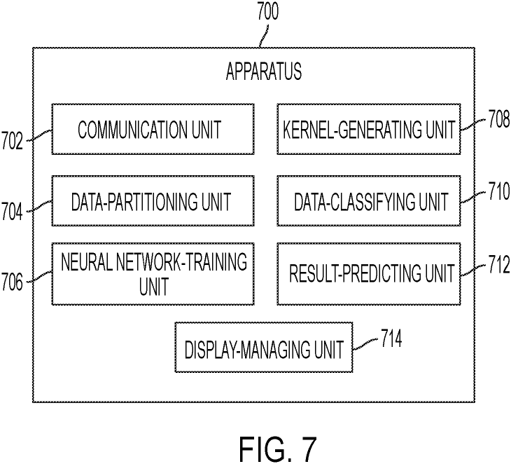

FIG. 7 presents an exemplary apparatus 700 which facilitates construction of an ensemble of neural network kernel classifiers, in accordance with an embodiment of the present application. Apparatus 700 can comprise a plurality of units or apparatuses which may communicate with one another via a wired, wireless, quantum light, or electrical communication channel. Apparatus 700 may be realized using one or more integrated circuits, and may include fewer or more units or apparatuses than those shown in FIG. 7. Further, apparatus 700 may be integrated in a computer system, or realized as a separate device which is capable of communicating with other computer systems and/or devices. Specifically, apparatus 700 can comprise units 702-714 which perform functions or operations similar to modules 620-632 of computer system 602 of FIG. 6, including: a communication unit 702; a data-partitioning unit 704; a neural network-training unit 706; a kernel-generating unit 708; a data-classifying unit 710; a result-predicting unit 712; and a displaying-managing unit 714.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-executable method for facilitating construction of an ensemble of neural network kernel classifiers, the method comprising:
dividing a training set of data objects into a number of partitions;
training, based on the training set of data objects, a first neural network encoder to output a first set of features;
training, based on each respective partition of the training set of data objects, a second neural network encoder to output a second set of features;
generating, for each respective partition, based on the first and second set of features, kernel models which output a third set of features;
classifying, by a classification model, the training set of data objects based on the third set of features,
wherein the generated kernel models for each respective partition and the classification model comprise the ensemble of neural network kernel classifiers; and
predicting a result for a testing data object based on the ensemble of neural network kernel classifiers.

2. The method of claim 1,
wherein dividing the training set of data objects into the number of partitions comprises dividing the training set of data objects into a number of classes based on a respective class associated with a respective data object.

3. The method of claim 1,
wherein dividing the training set of data objects into the number of partitions comprises dividing the training set of data objects randomly into the number of partitions.

4. The method of claim 1, wherein a respective kernel model comprises one or more of:
a Gaussian kernel;
a universal kernel in a Reproducing Kernel Hilbert Space;
a linear kernel;
a kernel mapping; and
a kernel with a corresponding closed-form mathematical expression.

5. The method of claim 1, wherein the classification model comprises one or more of:
a linear classifier;
a logistic regression classifier; and
a multiple-class classifier.

6. The method of claim 1,
wherein the classification model comprises a softmax classification layer.

7. The method of claim 1,
wherein the first neural network encoder, a respective second neural network encoder trained based on a respective partition, a respective kernel model generated for the respective partition, and a classification model comprise a combined neural network kernel model which is based on parameters.

8. The method of claim 7, further comprising:
determining a forward iteration, wherein an input of the combined neural network kernel model comprises the training set of data objects and data objects in the respective partition; and
defining a back propagation iteration, wherein known labels of the training set of data objects enable the combined neural network kernel model to change one or more parameters to ensure that the classification of the training set of data objects is consistent with the known labels.

9. The method of claim 1,
wherein the testing data object is modified based on an adversarial technique.

10. A computer system for facilitating construction of an ensemble of neural network kernel classifiers, the computer system comprising:
a processor; and
a storage device storing instructions that when executed by the processor cause the processor to perform a method, the method comprising:
dividing a training set of data objects into a number of partitions;
training, based on the training set of data objects, a first neural network encoder to output a first set of features;
training, based on each respective partition of the training set of data objects, a second neural network encoder to output a second set of features;
generating, for each respective partition, based on the first and second set of features, kernel models which output a third set of features;
classifying, by a classification model, the training set of data objects based on the third set of features,
wherein the generated kernel models for each respective partition and the classification model comprise the ensemble of neural network kernel classifiers; and
predicting a result for a testing data object based on the ensemble of neural network kernel classifiers.

11. The computer system of claim 10,
wherein dividing the training set of data objects into the number of partitions comprises dividing the training set of data objects into a number of classes based on a respective class associated with a respective data object.

12. The computer system of claim 10,
wherein dividing the training set of data objects into the number of partitions comprises dividing the training set of data objects randomly into the number of partitions.

13. The computer system of claim 10, wherein a respective kernel model comprises one or more of:
a Gaussian kernel;
a universal kernel in a Reproducing Kernel Hilbert Space;
a linear kernel;
a kernel mapping; and
a kernel with a corresponding closed-form mathematical expression.

14. The computer system of claim 10, wherein the classification model comprises one or more of:
a linear classifier;
a logistic regression classifier;
a multiple-class classifier; and
a softmax classification layer.

15. The computer system of claim 10,
wherein the first neural network encoder, a respective second neural network encoder trained based on a respective partition, a respective kernel model generated for the respective partition, and a classification model comprise a combined neural network kernel model which is based on parameters.

16. The computer system of claim 15, wherein the method further comprises:
determining a forward iteration, wherein an input of the combined neural network kernel model comprises the training set of data objects and data objects in the respective partition; and
defining a back propagation iteration, wherein known labels of the training set of data objects enable the combined neural network kernel model to change one or more parameters to ensure that the classification of the training set of data objects is consistent with the known labels.

17. The computer system of claim 10,
wherein the testing data object is modified based on an adversarial technique.

18. A non-transitory computer-readable storage medium storing instructions that when executed by a computer cause the computer to perform a method, the method comprising:
dividing a training set of data objects into a number of partitions;
training, based on the training set of data objects, a first neural network encoder to output a first set of features;
training, based on each respective partition of the training set of data objects, a second neural network encoder to output a second set of features;
generating, for each respective partition, based on the first and second set of features, kernel models which output a third set of features;
classifying, by a classification model, the training set of data objects based on the third set of features,
wherein the generated kernel models for each respective partition and the classification model comprise an ensemble of neural network kernel classifiers; and
predicting a result for a testing data object based on the ensemble of neural network kernel classifiers.

19. The storage medium of claim 18,
wherein dividing the training set of data objects into the number of partitions comprises dividing the training set of data objects into a number of classes based on a respective class associated with a respective data object.

20. The storage medium of claim 18,
wherein the first neural network encoder, a respective second neural network encoder trained based on a respective partition, a respective kernel model generated for the respective partition, and a classification model comprise a combined neural network kernel model which is based on parameters.
